(19) United States
(12) Patent Application Publication
(10) Pub. No.: US 2024/0268408 A1
(43) Pub. Date: Aug. 15, 2024

(54) HYDROTHERMAL REFINING PROCESS

(71) Applicant: Applied Research Associates, Inc., Albuquerque, NM (US)

(72) Inventors: Charles Red, JR., Youngstown, FL (US); Edward N. Coppola, Panama City, FL (US); Sanjay Nana, Panama City, FL (US); Jocelyn Marie Goodwin, Panama City, FL (US); Curt Beckemeyer, Panama City Beach, FL (US)

(21) Appl. No.: 18/441,891

(22) Filed: Feb. 14, 2024

Related U.S. Application Data
(60) Provisional application No. 63/445,402, filed on Feb. 14, 2023.

(51) Int. Cl. A23D 9/04

(52) U.S. Cl. CPC A23D 9/04

(57) ABSTRACT

Systems and methods of refining any of crude vegetable oil, plant oils, fats, oils, greases, or soaps to meet edible oil specifications. The refining including mixing the crude oil feedstock with water and at least reactant, to form a mixture; feeding the mixture into a hydrothermal reactor and subjecting to heat, pressure, and turbulent flow conditions to cause rapid hydrolysis of phospholipids and reaction of the inorganic contaminants with the reactant to form inorganic salts; maintaining the temperature, pressure, and turbulent flow conditions of the mixture for a predetermined space time to prevent the organic portion of the mixture from undergoing a conversion reaction and to form a hydrothermal reactor effluent.

### RELATED APPLICATIONS

This application claims priority to earlier-filed U.S. Provisional Patent Application No. 63/445,402, entitled “HYDROTHERMAL REFINING PROCESS.” This application shares certain subject matter in common with earlier-filed U.S. Pat. No. 10,071,322, entitled “HYDROTHERMAL CLEANUP PROCESS.” This patent application shares certain subject matter in common with earlier-filed U.S. Pat. No. 11,781,075, entitled “HYDROTHERMAL PURIFICATION PROCESS.” This patent application shares certain subject matter in common with earlier-filed U.S. Patent Application Publication No. 2014/0109465, entitled “HIGH RATE REACTOR SYSTEM.” The above-referenced patents and patent applications are hereby incorporated by reference in their entirety into the present application.

### BACKGROUND

### 1. Field

Embodiments of the invention relate to removal of contaminants from food grade fat and oil feedstocks such as rendered fats, crude or crude degummed soybean, canola, corn, sunflower, peanut, olive, flaxseed, palm, coconut, sesame, avocado, rapeseed, cottonseed oils, or a blend thereof. More specifically, embodiments of the invention relate to a hydrothermal refining process that utilizes water, temperature, pressure, turbulent flow, and weak acid to achieve rapid phosphorous and metals reduction via hydrolysis and acidulation reactions and mass transfer of inorganic contaminants from crude or crude degummed food grade oils to an aqueous phase.

### 2. Related Art

Phospholipids are essential components of vegetable cell structure, commonly referred to as gums. These gums are extracted from the oil seeds along with the crude vegetable oil and, being oil soluble, remain in the extracted crude oil. One of the primary objectives of refining of crude vegetable oil is to reduce the phospholipids content in the oil to a very low level, typically less than 3 parts per million by weight (ppmw). Phospholipids content above a certain level may cause the oil to not perform satisfactorily in many applications. In conventional vegetable oil refining, crude oil is degummed to reduce the phosphorus content of the oil to a very low level because the phosphorus content of the oil has a profound influence on the flavor and stability of the refined, bleached, and deodorized oil. In addition, several process related issues are experienced when the oil contains high phosphorus past the bleaching stage. In the oil processing industry, the phospholipids content in the oil is expressed in terms of ppmw of phosphorus. This is because there is a definite relationship between the phospholipids content and the corresponding phosphorus level in the oil. There is approximately 300 ppmw of phosphorus per percent phospholipid in vegetable oils.

Various degumming processes are used in the vegetable oil industry. These processes include water degumming, acid conditioning, acid degumming, super degumming, and ultra degumming. Water degumming removes most of the hydratable phospholipids from the crude oil. The hydratable gums from crude oil are easily separated from the crude oil at a temperature of 60 to 65 degrees Celsius using deionized water. The oil and water are gently mixed in a hydration tank for 30 to 40 minutes. The hydrated gums separate and agglomerate. The hydrated gums are then centrifuged out of the oil. Acid degumming is very similar to water degumming except that an amount of classwork or citric acid is added to the water oil mixture which is then mixed in the hydration tank for 30 to 40 minutes at low temperature, such as under 275° C. Neither water nor acid degumming reduces phosphorus content down to edible grade oil specifications. Additional bleaching is required to remove residual phosphorus. Conventional chemical degumming of a plant or algal oils that are high in phospholipid content results in significant yield loss because the entire phospholipid diglyceride is removed from the treated oil.

The Colgate-Emery process is a continuous-flow, counter-current process that typically operates at 250-260° C. and 725 psig that is used for fat splitting. Oil is fed into the bottom of a splitting tower and demineralized water is fed into the top of the tower. Fatty acids are discharged from the top of the tower and a water-glycerin solution (sweet water) is removed from the bottom of the tower. Processing time is 2 to 3 hours, which requires very large, heated pressure vessels for large commercial applications. Several factors limit the performance of a Colgate-Emery process: 1) the need to operate below the glycerin decomposition temperature, which is approximately 290° C.; 2) the need to provide long residence time for hydrolysis and to permit gravity separation of free fatty acid and glycerin-water phases; 3) the need to use relatively clean, degummed feed stocks to prevent emulsion formation; and 4) the economical tradeoff between operating temperature, pressure, and residence time. Operation of the Colgate-Emery process at higher temperature requires higher pressure and risks decomposition of glycerin due to the long residence time at temperatures near 290° C. The large equipment required makes this process cost prohibitive for alternative fuel production due to the large volumes of oil that must be processed to achieve economic viability. Sweet water (a diluted solution of glycerin) may form an emulsion due to the presence of residual free fatty acids and partially hydrolyzed triglycerides. To recover the dilute glycerin product, sweet water typically must settle for up to 24 hours at 80-90° C. with demulsifying agents. Vacuum distillation may also be used to further separate long- and short-chain fatty acids.

Free fatty acids present in plant oils and those produced in the refining of plant oils must be removed from the oil to meet edible oil specifications. Soap stocks are formed during refining of edible oils where sodium hydroxide is used to remove free fatty acids from plant oils as sodium soaps. Soap stocks contain sodium soaps, phospholipids, and glycerides. Because clean free fatty acids are much more valuable as feed stocks for chemical production and other applications than soaps, acidulation using strong acids, such as sulfuric acid, is used to reverse the reaction at 90° C. to recover free fatty acids and sodium salts. In addition to the need for and use of a strong acid, the process results in the production of acidic effluents containing phospholipids and other compounds.

### SUMMARY

Embodiments of the invention solve the above-mentioned problems by providing systems, methods, and devices for a hydrothermal refining process that achieves rapid phosphorus and metals reduction of food grade oils. The process includes the step of combining the oil with water and at least one of metal scavengers and/or reactants, wherein the metal scavengers or reactants comprise salt or acid solutions, prior to or during feeding of the oil and water mixture into a hydrothermal reactor. Conditions within the reactor are maintained to cause rapid hydrolysis of phospholipid compounds and reaction of the inorganic contaminates with the acid and/or salt scavengers while preventing the oil from undergoing undesirable side reactions such as isomerization of cis to trans fatty acids, polymerization, or thermal cracking, and minimizing hydrolysis of tri- and diglycerides into free fatty acids. In some cases, the process and system are characterized by a very short residence time under turbulent flow and temperature and pressure controlled to maintain hydrothermal (saturated water) conditions.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 illustrates an exemplary schematic view of a hydrothermal system with acidulation in accordance with an embodiment the present disclosure for reducing contaminants contained in renewable feedstock that incorporates a tubular reactor and oil-water separator for the recovery of a purified renewable oil;

FIG. 2 illustrates a typical refinement method;

FIG. 3 illustrates an exemplary hydrothermal refinement method relating to some embodiments; and

FIG. 4 illustrates an exemplary hydrolysis reaction relating to some embodiments.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

Hydrothermal refining processes used as a pretreatment step for removing contaminants from waste fats, oils, and greases for use in follow-on production of renewable fats and oils utilize high temperature conditions, typically above 225° C. to fully hydrolyze phospholipids in the feedstock. However, the high temperature operation results in the production of free fatty acids, which contribute directly to yield loss in food-grade oil production. As such, embodiments of the present disclosure contemplate using relatively lower temperatures and higher flow rates to hydrolyze phospholipids, which may decrease the overall removal of phosphorus from the oil but minimizes production of free fatty acids from hydrolysis of glycerides. Typical refinement processes prioritize removal of phosphorus and thus, would not limit hydrolysis of phospholipids by reducing temperature and/or increasing flow to reduce hydrolysis of glycerides into free fatty acids. The higher flow rates contemplated produce more turbulent flow, better mixing of oil and water and lower residence times that prevent further hydrolysis of glycerides into the unwanted free fatty acids. The mild conditions contemplated produce a refined feedstock oil that is suitable for follow-on food-grade refining applications as opposed to feedstock products that contain almost no phosphorus and a substantial amount of free fatty acids.

Embodiments of the present disclosure are directed to a process and system for the refining of food grade oils feedstocks. This disclosure has numerous advantages over other refining processes such as water degumming, chemical degumming, enzymatic degumming, neutralization, bleaching, and other chemical, extraction, and filtration processes. Advantages include, but are not limited to: 1) equipment that exhibits a small footprint that can be co-located with a conventional oil seed crushing facilities; 2) a continuous-flow liquid-phase process; 3) the reduction of phosphorus to levels below those of other degumming processes; 4) the reduction of metals and silicon; 5) the reduction in production of solid wastes such as bleaching clay and other filtration media; 6) and the reduction of product yield loss from 3-5% or more to less than 0.5%. The system is specifically desirable for use in processing food grade oils feedstocks. At the temperature employed in hydrothermal refining, renewable oil and water phases are partially miscible. In addition, under the turbulent flow, high-Reynolds-number conditions employed during hydrothermal refining, renewable oil and water phases become intimately mixed and well dispersed into small droplet size. This results in rapid mass transfer between phases, rapid hydrolysis of phospholipids and conversion of metal soaps of organic acids into salts that rapidly partition to the aqueous phase during subsequent oil-water separation. The addition of metal scavengers and/or reactants, wherein the metal scavengers and reactants comprise salt or acid solutions, along with water, prior to or during the feeding of the feedstock into the hydrothermal reactor accelerates the conversion of metal soaps to salts resulting in refined product oil that contains less than 10 parts per million (ppm) total metals content. Conditions within the refining reactor are maintained in a manner that achieves these reactions in a space time of less than 10 minutes while minimizing undesirable side reactions such as hydrolysis of mono-, di-, and triglycerides, isomerization of cis to trans fats, polymerization, and thermal cracking.

The diglyceride residual produced by the hydrolysis of phospholipids is not only recovered in the oil phase resulting in greater than 99.5% yield, but oil and water phases can be more easily separated with no rag layer formation or residual effluent generation that is caused by the presence of phospholipids.

In accordance with one embodiment of the disclosure, a process for reducing contaminants contained in food grade oils feedstocks comprises providing at least one of metal scavengers or reactants, wherein the metal scavengers or reactants comprise acid or salt solutions, or a combination of acid and salt solutions. The process includes mixing the metal scavengers or reactants with water and the food grade oils feedstocks to form an oil-water-reactant mixture and feeding the oil-water-reactant mixture into a hydrothermal reactor, wherein the mixture is subject to heat, pressure, and turbulent flow conditions. The process further includes maintaining the temperature, pressure, and turbulent flow conditions of the oil-water-reactant mixture, in the hydrothermal reactor, in a manner that causes rapid reaction of the inorganic contaminants with the metal scavenger or reactants to form inorganic salts that partition into an aqueous phase. The process further includes maintaining the temperature, pressure, and turbulent flow conditions of the oil-water-reactant mixture in the hydrothermal reactor so as to prevent the organic portion of the feedstock in the mixture from undergoing hydrolysis of mono-, di-, and triglycerides, isomerization of unsaturated compounds from the “cis-” isomer to the “trans-” isomer, thermal cracking of lipid carbon-carbon bonds into lower molecular weight fragments, and polymerization into higher molecular weight hydrocarbons. The hydrothermal reactor effluent is separated into an aqueous phase containing salts of the inorganic contaminants, and a refined organic phase that contains a very low concentration of phosphorus and metals relative to the unrefined, crude oil.

The food grade oils feedstocks can be comprised of lipid-type oils including, but not limited to vegetable oils, virgin plant oils; tri-, di- and monoglycerides; free fatty acids; lecithin, gums and phospholipids; soaps of fatty acids; deodorizer distillates; acid oil; crude tall oil and derivatives; waste fats, oils, and greases; distillers corn oil; algal oils; microbial oils; bio-oils, or mixtures or water emulsions thereof. It can be appreciated that different oils may be blended in proportions that will improve processability, performance, and economics.

The unrefined oil and metal scavengers or reactants, comprising salt or acid solutions or mixtures thereof, can be mixed by combining the streams using tee connections, static mixers, pumps, mixing valves, and the like, while the mixture is maintained in turbulent flow to form an oil-water-reactant mixture. The metal scavengers and/or reactants can be added to the water stream before mixing with the oil or can be added to the oil-water mixture before entering the hydrothermal reactor or can be added at any point along the process, including at a point after processing in the hydrothermal reactor. It can be appreciated that the metal scavengers or reactants may include strong acids, weak acids including carbonic acid, organic acids, salts, and mixtures thereof.

The hydrothermal reactor can comprise a tubular reactor designed to maintain turbulent flow conditions at Reynolds numbers equal to or greater than 4,000. In some embodiments, turbulent flow refers to a flow condition characterized by the disruption among layers of a flowing fluid. Further, the disruption among layers of the flowing fluid facilitates mixing among the layers as compared to laminar flow consisting of parallel layers of flowing fluids with little to no mixing among the layers. The oil-water-reactant mixture can be heated to a reaction temperature within a range from 150° C. to 350° C. The pressure in the hydrothermal reactor can be maintained within a range from 100 psig to 2,500 psig and is controlled to maintain the mixture in a liquid, hydrothermal phase. At these conditions, the space time of the feedstock-water-reactant mixture in the hydrothermal reactor can range from approximately 10 seconds to 15 minutes, 10 seconds to 10 minutes, or 10 seconds to 5 minutes.

Alternatively, the hydrothermal reactor can operate at a pressure within a range from 100 psig to 1500 psig, a temperature within a range from 150° C. to 300° C., and a space time 10 seconds to 5 minutes. It can be appreciated that the pressure, temperature, and residence time used in the hydrothermal reactor can be determined based on several variables including the particular oil being refined, the concentration of phosphorus and metals in the oil, and the particular metal scavengers or reactants, comprising acid or salt solutions, that are mixed with the water and the unrefined oil. It can also be appreciated that the particular pressures, temperatures, and residence times can be outside of the parameters outlined above depending on the variables listed above and the level of phosphorus and metals reduction required. It can be appreciated that space time is commonly used in relation to flow reactors where reactions, fluid densities, or phases change within the reactor.

Space time is defined as the time necessary to process one reactor volume of fluid based on entrance conditions (standard temperature and pressure). Because hydrothermal (liquid phase) conditions are maintained, the density of the oil-water-reactant mixture at operating temperatures between 150° C. and 300° C. is lower than the density at entrance conditions. This means that the actual residence time of the oil-water-reactant mixture is lower than the space time at the operating temperature.

The oil-water-reactant mixture can exist as a single-phase solution, an emulsion, or as a two-phase, oil-water-reactant mixture depending on operating temperature and solubility of the oil in water at the operating temperature. The water concentration of the oil-water-reactant mixture is controlled to maintain inorganic salt byproduct in solutions in the aqueous phase. The process of separating the reactor effluent into the aqueous stream and the organic product stream includes the steps of cooling, depressurizing, and separating to produce a clean refined oil stream and a water stream. Separation of oil phase from the aqueous phase can be conducted with use of at least one of a gravity separator, a gravity separator that includes electrostatic or coalescer elements, a hydro-cyclone, a centrifuge, and/or any combination thereof, and may be accelerated by use of demulsifying agents. Separation can be performed before or after cooling and pressure letdown. As food grade oil feedstocks may contain volatiles that affect the taste of the oil, traditional oil refining utilizes a separate deodorizing step for removing the volatiles from the oil which consists of sparging steam through the oil in order to vaporize and remove volatiles from the oil. If the separation is done prior to pressure letdown, the separator may be operated at a level where a portion of the water in the separator is allowed to flash and perform the sparging of the oil and removal of volatiles.

Embodiments also include a hydrothermal refining system for refining renewable oils comprised of a hydrothermal reactor system operated at temperature, pressure, and turbulent flow conditions to maintain a liquid, hydrothermal phase that results in rapid hydrolysis of phospholipids without causing thermal cracking of lipid carbon-carbon bonds, polymerization, or isomerization of the unrefined oil and a separation system for removing a clean refined oil product stream and water stream that contains inorganic contaminants.

In some embodiments, the hydrothermal reactor system is operated under turbulent flow conditions having a Reynolds Number (Re) of at least 4,000. In some such embodiments, an increased Reynolds Number, such as over 10,000 or over 20,000, achieves greater mass transfer of contaminants between the oil and water phases. The increased Reynolds Number may become more critical at lower operating temperatures, such as temperatures, below 250° C., where the solubility of water in the oil phase and solubility of oil in the water phase is much lower than at higher operating temperatures. The hydrothermal reactor system can be operated at a pressure within the range from 100 psig to 2,500 psig and a temperature within a range from 150° C. to 350° C. and wherein cleanup of the oils occurs at a space time of approximately 10 seconds to 15 minutes, 10 seconds to 10 minutes, or 10 seconds to 5 minutes. Alternatively, the hydrothermal reactor can be operated at a pressure within a range of from 100 psig to 1500 psig, a temperature within a range from 150° C. to 300° C., and a space time of 10 seconds to 2 minutes. In some embodiments, the hydrothermal reactor can be operated at a pressure within a range of from 100 psig to 1500 psig, a temperature within a range from 150° C. to 275° C., and a space time of 10 seconds to 2 minutes. It can be appreciated that the ratio of water-to-oil, pressure, temperature, and residence time of the hydrothermal reactor system can be determined based on several variables including the particular oil being refined, the concentration of metals and phosphorus in the unrefined oil, and the particular metal scavengers and/or reactants, wherein the metal scavengers or reactants comprise acid or salt solutions that are mixed with the water and the unrefined oil. It can also be appreciated that the particular pressure, temperatures and space times can be outside of the parameters outlined above depending on the variables listed above and the level of contaminant reduction required.

Certain embodiments of the invention are directed to a continuous-flow process and system for the hydrothermal processing of renewable feedstocks, such as plant oils, algal and microbial oils, waste vegetable oils, brown grease, tallow, tall oil, acid oil, and bio-oils. The process of the present invention separates undesirable contaminants such as minerals, metals, and salts from the feedstock to produce clean, purified oil. By “clean” it is meant that contaminants in the product have been reduced by greater than 95%, such as by more than 99%, often resulting in trace amounts (near or below typical analytical method detection limits) of contaminants compared to the feedstock. The level of contaminants in the clean oil is minimized to greatly reduce challenges associated with contaminated oils in downstream food grade oil processing. The process is accomplished by hydrolysis, solvation, acidulation, and concentration of contaminants in the water effluent stream. The process does not include conversion of the feedstock. By “conversion” it is meant molecular rearrangement of lipids or FFAs, such as occurs in decarboxylation, thermal cracking, isomerization, cyclization, polymerization, hydrogenation, or dehydrogenation.

The feedstocks may be food grade fat and oil feedstocks such as rendered fats, crude or crude degummed soybean, canola, corn, sunflower, peanut, olive, flaxseed, palm, coconut, sesame, avocado, rapeseed, and cottonseed oils. Feedstocks can be in the form of mixtures and emulsions that impede or prevent conventional pretreatment operations. Contaminants that may be removed include inorganic elements, such as halides (e.g., Cl, Br, I), phosphorus and phosphorus-containing species, alkali metals and metalloids (e.g., B, Si, As), other metals (e.g., Na, K, Ca, Fe, Mg, Ni, V, Zn, Cr, Al, Sn, Pb, etc.), and organic compounds (proteins, polymers such as polyethylene). The process and system results in clean oil by achieving more than 95% (such as more than 99%) reduction in phosphorus, salt, mineral, and metal content. Hydrothermal purification (HTP) process conditions can be controlled in a manner that will retain triglycerides in feedstocks containing triglycerides, or process conditions can be adjusted to achieve rapid hydrolysis of triglycerides into free fatty acids. In feedstocks containing phospholipids, HTP process conditions can be controlled in a manner to reduce phosphorus content to less than 2 ppm at a fraction of the yield loss associated with conventional degumming. The system of the present invention includes a high-temperature, high-pressure, hydrothermal reactor system coupled with addition of acids, salts, or metal scavengers, and components for separation and/or recovery of a clean oil product with no other operations or additions therebetween. The integrated reactor and separation systems are the basis of the HTP process.

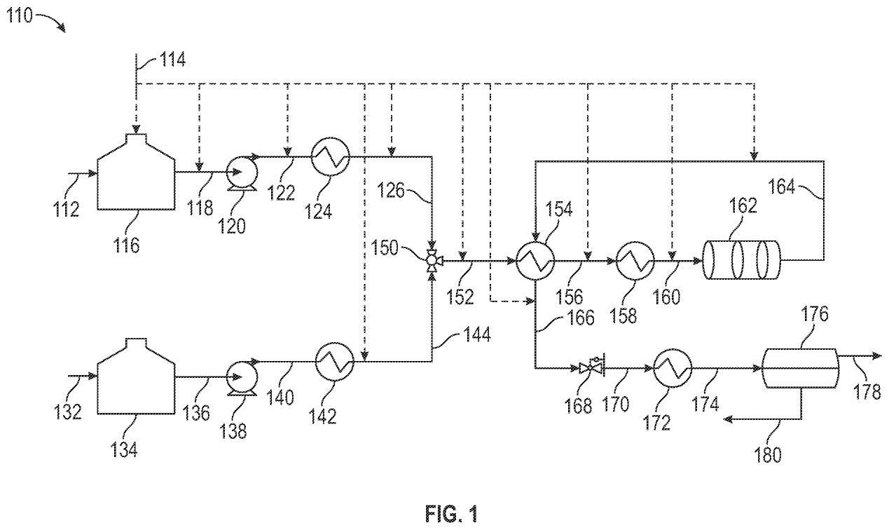

Reference is now made to FIG. 1, which shows a schematic view of the hydrothermal process and system, generally indicated as 110, in accordance with an embodiment of the invention, for the refining of food grade fat and oil feedstocks. The clean oil and water products are recovered by conventional oil-water separation processes. The process and system include providing a fat or oil feedstock 132. The contaminated feedstock 132 may be fed into an equalization tank 134. Generally, an equalization tank acts as a holding tank that allows for the equalization of flow of the feedstock. An equalization tank can also act as a conditioning operation where the temperature of the feedstock is controlled to maintain desired flow characteristics. The contaminated feedstock exits the equalization tank 134 at stream 136 and enters into pump 138 to form a pressurized feed stream 140. The pressurized feed stream 140 can be preheated by a heating device, such as a heat exchanger 142, to form a heated feed stream 144.

A water feed stream 112 can be supplied to an equalization tank 116 and fed at stream 118 to a pump 120 to form a pressurized water stream 122. The pressurized water stream 122 can be heated by a heating device, such as a heat exchanger 124, to form a heated water stream 126. It should be appreciated that streams 126 and 144 can be heated by any known process or device and includes heat recovery from other process streams to optimize overall thermal efficiency. Reactants and/or metal scavenger salts or solutions are added at stream 114. It can be appreciated that stream 114 can be added at any location throughout the refining process, such as into the equalization tank 116 and/or to streams 118, 122, 126, 144, 152, 156, 160, 164, 166. It can also be appreciated that the reactants and/or metal scavengers can be simultaneously added at any combination of these locations.

The heated organic feed stream 144 and heated water stream 126 are mixed at mixing device 150 to form a high-pressure mixed stream 152. Sufficient pressure is required to maintain the feedstock and water streams in liquid phase at conditions necessary to accomplish metals reduction and phospholipid hydrolysis based on the feedstock contaminants. Renewable feedstocks may become miscible with water at temperatures as low as 300° C. and pressure as low as 1,250 psig. It can be appreciated that the mixing device 150 may be a combination of the two streams via a tee connection or may include one or more conventional static mixers, mixing valves, or pumps. The type of mixing device and degree of mixing are dependent on the feedstock, the flow properties of the feedstock, and miscibility of the feedstock with water. As shown in FIG. 1, the reactants and/or metal scavenger salts of stream 114 can also be added to stream 152. The high-pressure mixed stream 152 is heated in a feed-effluent heat exchanger 154 to form a heated stream 156. It can be appreciated that the feed-effluent heat exchanger 154 can be any combination of heat exchangers configured throughout the process to maximize overall thermal efficiency. For example, heat exchanger 154 may be a countercurrent shell-and-tube heat exchanger configured to transfer heat from a reactor effluent stream (e.g., effluent 164, discussed below) to a reactor feed stream (e.g., stream 152) to reduce the overall cost of heating and/or cooling the streams within hydrothermal system 110. Stream 156 is fed to heater 158, which can be any type of heater or heat exchanger, which heats the oil-water mixture up to the target treatment temperature, such as within the range from 150° C. to 350° C., at stream 160 before it enters a hydrothermal reactor 162.

The hydrothermal reactor 162 operates at high Reynolds numbers (at least or greater than 2000) which creates turbulent fluid dynamics; and achieves rapid mixing, mass transfer, and heat transfer. This enables the hydrothermal reactor to operate at much shorter space times and at higher operating temperatures than the prior art systems for degumming (50-60° C.) or for fat-splitting via the Colgate-Emery process (250-260° C.). At these conditions, the hydrothermal reactor 162 achieves greatly reduced reactor size relative to prior art systems. The operating conditions of the hydrothermal reactor 162 may be selected based on the contaminants in the feedstock and the cleanup requirements. The water-to-oil weight ratio in the hydrothermal reactor 162 may be between 1:100 and 3:1, such as between 1:10 and 1:1. The hydrothermal reactor 162 is operated at sufficient pressure to maintain liquid phase such as in the range of 250-3,000 psig or 500-1,500 psig. The hydrothermal reactor 162 is configured to achieve and operate at turbulent flow conditions to optimize mixing and maximize mass and heat transfer. At operating temperature and pressure, space times range from less than or up to 10 seconds to 15 minutes depending on the particular feedstock and contaminant reduction requirements. As used herein, space time is calculated based on the reactor volume and the volume of the feedstocks at standard conditions (temperature of 20° C. and pressure of one atmosphere). Actual hydraulic residence times may be calculated based on operating conditions (temperature and pressure) and the water-to-oil weight ratio. The hydrothermal reactor 162 can be a tubular reactor. It can be appreciated that the hydrothermal reactor can be operated as an adiabatic reactor due to the very short space time, or as an isothermal reactor. Different reactor conditions provide a range of mixing, heat transfer, space time, and product quality scenarios suited for the feedstock type and contaminant reduction requirements.

In general, tubular systems will exhibit a Reynolds Number (Re) of at least 2,000, within the range of 2,000-4,000, higher than 4,000, or higher than 10,000, resulting in turbulent flow, intimate mixing, and high heat and mass transfer rates. According to one embodiment, the present invention can employ a combination of space times less than or up to 15 minutes and Reynolds Number (Re) greater than 4,000 throughout the hydrothermal reaction zone. One example of a hydrothermal reactor 162 that can be used is the high-rate reactor disclosed in U.S. Pat. No. 10,071,322, the disclosure of which is incorporated herein in its entirety.

Therefore, the hydrothermal reactor is operated at conditions where conversion reactions do not occur and where coke that would affect performance is not formed. Instead, inorganic contaminants are liberated at hydrothermal operating conditions and removed by the integrated hydrothermal reactor and oil-water separation systems.

Effluent 164 of the hydrothermal reactor 162 is cooled in the feed-effluent heat exchanger 154, yielding a partially-cooled product stream 166, which then passes through a pressure control valve 168 that maintains system pressure. The reactants and/or metal scavenger salts of stream 114 can also be added to stream 164 after exiting the hydrothermal reactor 162. Depressurized product stream 170 is further cooled as necessary by a cooling heat exchanger 172. A cooled product stream 174 is then fed to an oil-water separator 176. Separation of oil phase from the aqueous phase can be conducted with use of at least one of a gravity separator, a gravity separator that includes electrostatic or coalescer elements, a hydro-cyclone, a centrifuge, and/or any combination thereof and may be accelerated by use of demulsifying agents to reduce product moisture content. It can be appreciated that separation can be performed before or after pressure letdown depending on subsequent treatment of the clean product oil. After partial cooling, a high-pressure separator can be employed to produce a pressurized clean product oil for subsequent treatment to eliminate the need for an additional pumping operation. The high-pressure separator may be operated at a pressure where some of the water effluent flashed to steam to accomplish a deodorizing step in the oil product thereby removing volatile components. Clean product oil 178 and process water stream 180 are removed from the separator 176. The hydrothermal system 110, operated as described above, rapidly dissociates inorganic contaminants (e.g., salts, minerals, and/or metals) which partition into the process water stream 180 and greater than 95% (such as at least up to 99%) of the contaminants are eliminated from the contaminated feedstock 132.

The clean oil 178 may be further processed utilizing conventional food grade oil refining processes such as bleaching, hydrogenation, deodorization, and neutralization.

The process water stream 180 may be treated and reused, further processed to recover byproducts, applied to land, de-watered and used as an animal feed supplement, or treated in conventional wastewater treatment processes (not shown). The fate of the process water stream 180 is dependent at least in part on the constituents of the feedstock and the water recovery and reuse objectives. For instance, when the hydrothermal system 110 is used for desalting the feedstock, the process water stream 180 may contain both inorganic and trace organic contaminants and may be sent directly to wastewater treatment.

Alternatively, system 110 may be used for degumming or phosphorus removal. Rapid phosphorus removal is most effectively accomplished in the liquid phase where the temperature and pressure are controlled to maintain water in the saturated phase. Rapid hydrolysis of phospholipids in hydrothermal reactor 162 is achieved by cleaving the phosphate group from the glycerin backbone of a phospholipid as well as cleaving groups that may include fatty acids and other organic constituents from the phospholipid such as choline, ethanolamine, serine, or inositol constituents of phospholipids. In some embodiments, for example, rapid hydrolysis refers to hydrolysis that occurs within a predetermined time period. For example, rapid hydrolysis may refer to hydrolysis occurring within 10 seconds, 15 seconds, 30 seconds, 1 minute, 2 minutes, 5 minutes, or 10 minutes. Alternatively, in some embodiments, rapid hydrolysis refers to hydrolysis that occurs within the predetermined space time as described herein. For example, rapid hydrolysis may refer to a particular amount of hydrolysis occurring within a particular percentage of the overall space time.

Phosphate is removed in the aqueous phase of the reaction mixture, while the fatty acids, which typically represent over 70 wt. % of a phospholipid, are retained for subsequent processing into chemicals or fuels. The phosphorus content of clean oil 178 from the feedstock high in phospholipid content may be reduced from greater than 500 ppm to less than 2 ppm and total metal content may be reduced to less than 10 ppm. The yield of low-phosphorus oil from oil high in phospholipids is greatly increased compared to conventional degumming processes. For example, for an algal oil containing 6,000 ppm of phosphorus, the process of the present invention may increase the yield of low-phosphorus oil by 20%, whereby the clean oil 178 includes clean FFAs with a low phosphorus content. The process water stream 180 includes water and phosphate ion (PO43-) and may be recovered and reused as a nutrient source for growing crops or algae.

An advantage of the food-grade oil refining process and system relating to some embodiments of the present invention is that the small physical footprint of the system 110 requires low capital and operating costs. The hydrothermal process can operate at very short space times, such as less than two minutes. This results in relatively small equipment and low capital cost. When used for degumming, operating costs for hydrothermal refining are lower than conventional chemical degumming because less degumming acids are required, and in some embodiments, degumming acids are not required. Products and byproducts are easily separated and recovered using conventional oil-water separation technology, high-quality water may be recovered and reused without additional treatment, other valuable byproducts, such as glycerin, may be recovered, and no other liquid or solid waste products are generated. The present invention accomplishes rapid acidulation without the need for a strong mineral acid, to obtain clean lipid products without the formation of residual waste streams cause by the presence of phospholipids because phospholipids are hydrolyzed during hydrothermal purification. The diglyceride residual produced by the hydrolysis of phospholipids is not only recovered to improve yield, but oil and water phases can then be easily separated with no rag layer formation or residual effluent generation.

It should be appreciated that optimal operating conditions are dependent on feedstock quality and operating conditions can be varied and supplemented with conventional food grade oil refining steps to minimize conversion of cis to trans isomers in the organic product and achieve food grade product quality standards including maximum contaminant level, organoleptic, peroxide level, color, free fatty acid content, and stability. Operating conditions can be varied to maximize acidulation or maximize phospholipid hydrolysis. For example, an increase in temperature may increase acidulation and/or increase phospholipid hydrolysis.

The following Examples are presented to demonstrate the general principles of reducing contaminants in feedstock using HTP. All amounts listed are described in parts by weight, unless otherwise indicated. The invention should not be considered as limited to the specific Examples presented. Whereas particular embodiments of this invention have been described above for purposes of illustration, it will be evident to those skilled in the art that numerous variations of the details of the present invention may be made without departing from the invention as defined in the appended claims.

### EXAMPLES

### Example 1: Crude Soybean Oil (Varying Temperature and Space Time)

Crude soybean oil is typically refined, bleached, and deodorized through a multistep process to achieve a product low in phosphorus and metals. The crude soybean oil used in this example had not been refined and contained over 900 ppm of phosphorus and over 600 ppm of other metals. Crude soybean oil was fed to a pilot scale hydrothermal purification system that was configured as shown in FIG. 1. The tubular plug flow reactor was designed to achieve a 2-6 minute space time based on the combined volumetric flow rates of water and oil and to maintain a Reynolds Number greater than 4000. Operating conditions are shown in Table 1. Pressure was controlled at 1200 psig, which ensured that liquid-phase, hydrothermal conditions were maintained. Citric acid was added to the feed water to achieve an acid dose rate equivalent to 16-30 mmol of citric acid per liter of oil feed. The oil and water were gravity separated at 80° C. in the product separator.

TABLE 1
Operating Conditions for Example 1

| Parameter | Value |
|---|---|
| Water-to-oil ratio, v/v | 0.3 |
| Reactor temperature, ° C. | 225-250 |
| Reactor pressure, psig | 1200 |
| Space time, min | 2-6 |
| Reactor Reynolds Number, Re | >10,000 |
| Acid dose rate, mmol/L of oil | 16-30 |

Table 2 compares the feed and product properties. Phosphorus content was reduced from 975 ppm to 2.3 ppm or by 99.8% at an operating temperature of 250° C. and 5 minutes of space time. Metals reduction was similar for all conditions. These results show that increasing temperature or time will remove more phosphorus but will also increase the total acid number (TAN). An increase in TAN denotes the hydrolysis of glycerides and the production of free fatty acids, which would require neutralization to make food grade oils. The best compromise of phosphorus and TAN was achieved with 236° C. and 2 minutes of space time.

TABLE 2
Feed and Product Properties for Example 1

| | | | Space | | | Total | | TAN |
|---|---|---|---|---|---|---|---|---|
| | Temp. | Temp. | Time | P | % P | Metals | % Metals | mg KOH |
| | (° C.) | (° F.) | (min) | (ppm) | Reduced | (ppm) | Reduced | per g oil |
| Feed | | | | 975 | | 633 | | 1.5 |
| Product | 225 | 437 | 6 | 6.0 | 99.4 | 4.2 | 99.3 | 8.1 |
| 1 | | | | | | | | |
| Product | 236 | 457 | 2 | 5.7 | 99.4 | 1.7 | 99.7 | 4.0 |
| 2 | | | | | | | | |
| Product | 250 | 482 | 3 | 6.8 | 99.3 | 5.8 | 99.1 | 10.0 |
| 3 | | | | | | | | |
| Product | 250 | 482 | 5 | 2.3 | 99.8 | 2.8 | 99.6 | 15.1 |
| 4 | | | | | | | | |

### Example 2: Crude Soybean Oil

Crude soybean oil is typically refined, bleached, and deodorized through a multistep process to achieve a product low in phosphorus and metals. The crude soybean oil used in this example had not been refined and contained over 500 ppm of phosphorus and over 260 ppm of other metals. Crude soybean oil was fed to a pilot scale hydrothermal purification system that was configured as shown in FIG. 1. The tubular plug flow reactor was designed to achieve a 2-minute space time based on the combined volumetric flow rates of water and oil and to maintain a Reynolds Number greater than 4000. Operating conditions are shown in Table 3. Pressure was controlled at 1000 psig, which ensured that liquid-phase, hydrothermal conditions were maintained. Citric acid was added to the feed water to achieve an acid dose rate equivalent to 11.4 mmol of citric acid per liter of oil feed. The oil and water were gravity separated at 80° C. in the product separator.

TABLE 3
Operating Conditions for Example 2

| Parameter | Value |
|---|---|
| Water-to-oil ratio, v/v | 0.3 |
| Reactor temperature, ° C. | 275 |
| Reactor pressure, psig | 1000 |
| Space time, min | 2 |
| Reactor Reynolds Number, Re | >4,000 |
| Acid dose rate, mmol/L of oil | 11.4 |

Table 4 compares the feed and product properties. Phosphorus content was reduced from 510 ppm to 2.9 ppm or by 99.5%. Metals content was reduced to less than 1 ppm. The TAN increased only slightly indicating that near complete hydrolysis of phospholipids was achieved with essentially no hydrolysis of triglycerides or of the organic backbone of the phospholipid.

TABLE 4
Feed and Product Properties for Example 2

| Property | Feed | Product |
|---|---|---|
| TAN (mg KOH/g oil) | 1.0 | 5.6 |
| P (ppm) | 510 | 2.9 |
| Ca (ppm) | 55.2 | <0.1 |
| Mg (ppm) | 41.4 | <0.1 |
| Na (ppm) | <0.1 | <0.1 |
| K (ppm) | 172.7 | <0.1 |
| Fe (ppm) | 0.5 | <0.1 |

### Example 3: Crude Soybean Oil (Lower Operating Temperature)

Crude soybean oil is typically refined, bleached, and deodorized through a multistep process to achieve a product low in phosphorus and metals. The crude soybean oil used in this example had not been refined and contained over 800 ppm of phosphorus and over 650 ppm of other metals. Crude soybean oil was fed to a pilot scale hydrothermal purification system that was configured as shown in FIG. 1. The tubular plug flow reactor was designed to achieve a 2-minute space time based on the combined volumetric flow rates of water and oil and to maintain a Reynolds Number greater than 4000. Operating conditions are shown in Table 5. Pressure was controlled at 1200 psig, which ensured that liquid-phase, hydrothermal conditions were maintained. Citric acid was added to the feed water to achieve an acid dose rate equivalent to 29.4 mmol of citric acid per liter of oil feed. The oil and water were gravity separated at 80° C. in the product separator and then separated further in a heated centrifuge.

TABLE 5
Operating Conditions for Example 3

| Parameter | Value |
|---|---|
| Water-to-oil ratio, v/v | 0.3 |
| Reactor temperature, ° C. | 225 |
| Reactor pressure, psig | 1200 |
| Space time, min | 2 |
| Reactor Reynolds Number, Re | >10,000 |
| Acid dose rate, mmol/L of oil | 29.4 |

Table 6 compares the feed and product properties. Phosphorus content was reduced from 853 ppm to 9.6 ppm or by 98.9% at an operating temperature of 225° C. Metals content was reduced to less than 1 ppm. The TAN increased only slightly indicating that near complete hydrolysis of phospholipids was achieved with essentially no hydrolysis of triglycerides or of the organic backbone of the phospholipid. The remaining products show the effects of increasing temperature that produces more complete hydrolysis of phospholipids and increases hydrolysis of glycerides.

TABLE 6
Feed and Product Properties for Example 3

| | | | | Space | | | Total | % | TAN |
|---|---|---|---|---|---|---|---|---|---|
| | Temp. | Temp. | Water | Time | P | % P | Metals | Metals | mg KOH |
| | (° C.) | (° F.) | Ratio | (min) | (ppm) | Reduced | (ppm) | Reduced | per g oil |
| Feed | | | | | 853 | | 472.9 | | 1.3 |
| Product | 225 | 437 | 0.3 | 2 | 9.6 | 98.9 | 1.1 | 99.8 | 3.4 |
| 1 | | | | | | | | | |
| Product | 240 | 464 | 0.3 | 2 | 5.0 | 99.4 | 0.6 | 99.9 | 3.8 |
| 2 | | | | | | | | | |
| Product | 250 | 482 | 0.3 | 2 | 3.0 | 99.6 | 0.5 | 99.9 | 4.4 |
| 3 | | | | | | | | | |
| Product | 260 | 500 | 0.3 | 2 | 2.1 | 99.8 | 0.3 | 99.9 | 5.2 |
| 4 | | | | | | | | | |
| Product | 275 | 527 | 0.3 | 2 | 1.8 | 99.8 | 0.2 | 100.0 | 7.9 |
| 5 | | | | | | | | | |
| Product | 300 | 572 | 0.3 | 2 | 1.6 | 99.8 | 0.9 | 99.8 | 23.6 |
| 6 | | | | | | | | | |

In some embodiments of the present disclosure a hydrothermal refinement process is contemplated that may be applied to refining a variety of suitable fluids. For example, the hydrothermal refinement process may be used to refine any combination of fats, oils, and greases, as well as other suitable feedstock materials. In some such embodiments, the hydrothermal refinement process comprises combining water with the feedstock at high temperature and pressure under turbulent flow conditions to reduce phosphorus content of the feedstock. In some embodiments, the hydrothermal refinement process replaces a number of steps typically present in a traditional pretreatment process. For example, the hydrothermal refinement process described herein may replace any of degumming, bleaching, and filtering steps.

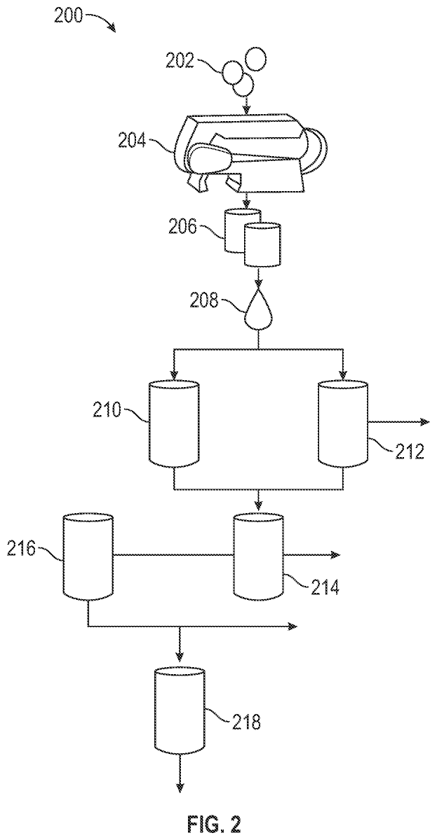

FIG. 2 illustrates a typical refinement method 200. In some embodiments, at least a portion of the steps described with respect to the refinement method 200 may be performed before, during, or after the hydrothermal refinement process described herein. The refinement method 200 is described with respect to a vegetable oil. However, it should be understood that, in some embodiments, the refinement method 200 may be applied to a variety of other feedstock materials.

At step 202, a raw oil seed is received. The raw oil seed may comprise a crude unrefined oil seed product. At step 204, a crush extraction process is performed to crush the oil seed and extract a fluid oil from the oil seed. At step 206, a hexane extraction process is performed to further extract oil from the crushed oil seed. The hexane extraction process may involve adding a hexane extracting agent to the oil seed. The hexane extracting agent may comprise a hexane-based solvent with a relatively low boiling point such that the hexane extracting agent may be easily separated after extraction. In some embodiments, the crush extraction and hexane extraction of steps 204 and 206 respectively may be performed simultaneously.

At step 208, a crude vegetable oil is received. The crude vegetable oil is received from the extraction steps after being extracted from the raw oil seed. At step 210 a neutralizing process is performed on the crude vegetable oil. The neutralization process may involve lightly heating the vegetable oil under continuous agitation to maintain uniformity of the vegetable oil. At step 212, a degumming process is performed on the crude vegetable oil. In some embodiments, the degumming process includes slowly heating the crude oil within a degumming vessel. The degumming process may be operable to remove phospholipids from the crude vegetable oil.

At step 214, a bleaching process is performed that includes adding a bleaching agent to the vegetable oil to remove one or more contaminates remaining in the neutralized and degummed vegetable oil. At step 216, the bleached vegetable oil may be filtered using one or more filtering techniques such as any of physical filtering or chemical filtering, as well as other suitable forms of filtration or combinations thereof.

At step 218, the vegetable oil is deodorized to remove one or more odor causing substances. In some embodiments, the deodorization step may involve heating the vegetable oil to boil away the odor causing substances.

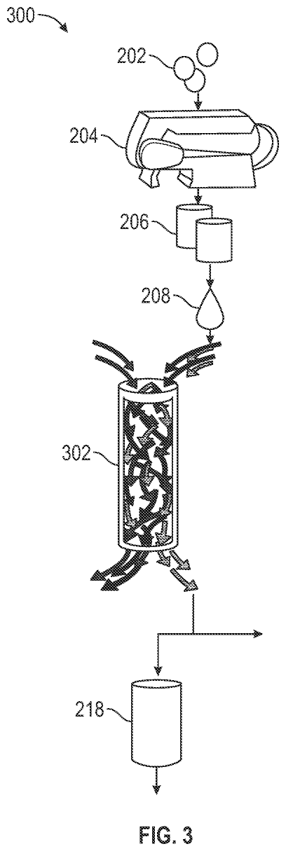

FIG. 3 illustrates an exemplary hydrothermal refinement method 300 relating to some embodiments. In some such embodiments, the hydrothermal refinement method 300 includes a number of steps used in the refinement method 200, as shown in FIG. 2. For example, the hydrothermal refinement method 300 may include steps 202-208 of receiving oil seed, crush extraction, hexane extraction, and receiving crude vegetable oil. However, in the hydrothermal refinement method 300 one or more steps of the refinement method 200 may be replaced with a hydrothermal refinement process at step 302.

At step 302, the hydrothermal refinement process may involve receiving the crude vegetable oil into a hydrothermal reactor along with water or another water-based fluid. The crude vegetable oil and water may be held within the hydrothermal reactor under pressure, mild heating, and turbulent flow conditions to permit hydrolysis of the crude vegetable oil. The hydrolysis reduces the total metals and phosphorus content of the vegetable oil such that metals, phosphorus, and other contaminates are removed as wastewater and a refined vegetable oil is produced.

In some embodiments, one or more reactions of the hydrolysis step are temperature and residence time dependent with the effectiveness of the hydrolysis relying on the operating temperature and residence time of the reactants. In some such embodiments, hydrolysis of phospholipids and gums includes hydrolyzing said phospholipids or gums into glycerides that partition into treated organic product and phosphate salts that partition into effluent water.

In some embodiments, various steps of the hydrothermal refinement process may be adjusted, added, or removed such that the process is more suitable for food-grade production. For example, in some embodiments, the process may not occur as a pretreatment stage and comprises a standalone treatment process. Further, in some embodiments, the hydrothermal refinement process may include substantially milder conditions to prevent the production of trans fat and maintain fatty acids in a straight condition, in addition to preventing the hydrolyzation of glycerides.

In some embodiments, the milder conditions of the food-grade hydrothermal refinement process minimize the production of free fatty acids, which would otherwise be neutralized and end up in a yield loss of the process. Further, in some embodiments the operating conditions of the food-grade hydrothermal refinement process reduces TAN and thereby denotes a reduction in the hydrolysis of glycerides and a reduction in the production of free fatty acids. According to some embodiments, the hydrothermal refinement process may be maintained at operating conditions that result in an increase in TAN of less than 1000%, less than 500%, less than 300%, or less than 200%. Some embodiments are contemplated in which the increase in TAN is less than 20 milligrams of potassium hydroxide per gram of oil (mg KOH/g oil), less than 10 mg KOH/g oil, less than 5 mg KOH/g oil, less than 3 mg KOH/g oil, or less than 2 mg KOH/g oil. Accordingly, parameters for the hydrolysis process, such as, for example, temperature and residence time, may be selected such that the phospholipids are hydrolyzed while reducing or preventing hydrolyzation of glycerides.

In some embodiments, parameters for the hydrolysis process, such as, for example, temperature, pressure, space time, and/or residence time, may be selected to reduce or prevent hydrolyzation of glycerides. For example, in some embodiments, hydrolysis of glycerides is limited such that an increase in total acid number of the organic portion of the oil-water mixture is less than 5 milligrams potassium hydroxide per gram of oil.

In some embodiments, the product of the hydrolyzation process contains 10-50 ppm of phosphorus. For example, the temperature and residence time may be reduced to prevent hydrolyzation of glycerides. In some such embodiments, the lower temperature and residence time prevents a full hydrolyzation of the phospholipids such that phosphorus still remains. Accordingly, the hydrolysis step may be followed by a bleaching step to further cleanse the product and remove the remaining phosphorus. In some such embodiments, the residence time may be reduced by increasing a flow rate of the oil feedstock producing a higher Reynolds number which increases phospholipid hydrolyzation while reducing hydrolyzation of other lipids.

In some embodiments, the hydrothermal refinement process described above may be used to treat soap stock. Further, in some embodiments, a neutralization step or caustic step may be included comprising the addition of sodium hydroxide or other suitable material to remove any free fatty acids, phospholipids, chlorophyll, and/or other color bodies remaining after the hydrolyzation. For example, in some embodiments, a caustic soda, such as sodium hydroxide in the form of any of flakes, pellets, powder, a solution, or another suitable form may be added during the caustic step to remove any of free fatty acids, phospholipids, chlorophyll, and other color bodies by neutralizing acids. In some embodiments, soaps are formed after hydrolyzation, which may be removed via rinse and centrifuge. In some embodiments, the hydrothermal refinement process may be used to pretreat soap stock by supplying the soap stock to the hydrothermal reactor with additional water and acidulation. The soap stock may be diluted into virgin oil, pretreated oil product, or acid oil from acidulation of the soap stock. In some embodiments, most of the soaps may be acidulated with sulfuric acid. A remainder of soaps may be acidulated with phosphoric acid or citric acid in the hydrothermal reactor. In some embodiments, excess sulfuric acid may be avoided to prevent damage to metallic components of the hydrothermal reactor or other metal components within the refinement system.

In some embodiments, a subsequent step of deodorizing may be performed after the hydrolysis and/or bleaching step to remove odor substances. For example, step 218 may be performed after the hydrolysis at step 302. In some such embodiments, the deodorization step involves a high temperature heating under vacuum conditions and addition of a stripping agent passing through the oil. In some embodiments, the deodorization step occurs at about 200° C. to evaporate the odor substances. Further, in some embodiments, the deodorization step includes a steam distillation process in which the stripping agent may comprise live steam.

Embodiments are contemplated in which the deodorization step may utilize heat and pressure remaining from the hydrolysis process. Further, in some embodiments, the deodorization step may occur during the hydrothermal refinement process and/or before a bleaching step. For example, a flashing step is included to partially flash the hydrolysis product thereby removing volatiles in the oil, which accomplishes the deodorization step as part of a pressure letdown and oil/water separation of the hydrothermal refinement process.

In some embodiments, an additional step of feeding the heated oil-water mixture from the hydrothermal reactor to a separator that separates the oil and water. Further, in some embodiments, the separator may be operated at a reduced pressure such that a portion of the water flashes to steam and passes through an oil phase. Accordingly, one or more volatile substances, such as volatile odor substance, may be stripped from the oil phase.

It should be understood that though the methods 200 and 300 are described with respect to refining a vegetable oil product the steps described herein may be applied to a variety of other suitable products such as, other types of oils, other organic compounds, soap stock, fats, and other substances not explicitly described herein.

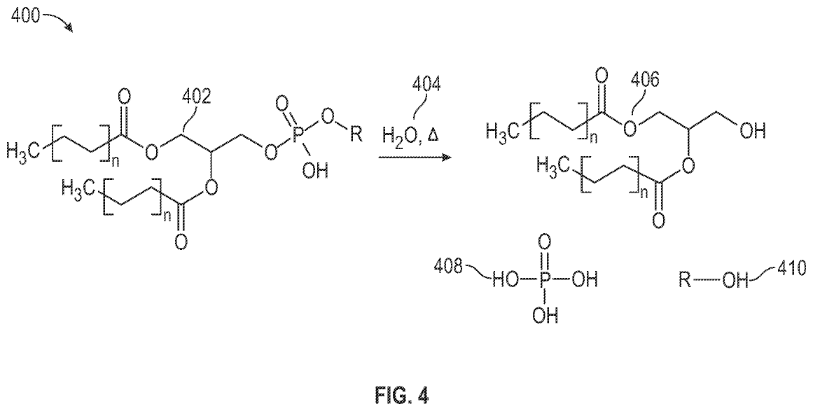

FIG. 4 illustrates an exemplary hydrolysis reaction relating to some embodiments referred to generally herein by reference numeral 400. In some embodiments, the reactants of the hydrolysis reaction 400 include a phospholipid 402, as shown. The phospholipid 402 may be reacted with water 404 under heat to produce one or more products, as shown. The products include a diglyceride 406, a phosphate salt 408, and a hydroxyl group 410, as shown. In some embodiments, the hydrolysis reaction 400 is temperature and residence time dependent. Further, in some embodiments, the hydrolysis reaction 400 may be carried out within a hydrothermal reactor such as at step 302. Thus, the phospholipids 402 are hydrolyzed into glycerides that partition into a treated organic product and phosphate salts, which may be carried away via effluent water.

In some embodiments, similar reactions may be facilitated for hydrolyzation of other types of organic compounds or substances. For example, in some embodiments, the hydrothermal refinement method 300 may be applied to organic chlorides such that the organic chlorides are hydrolyzed into organic acids that partition into a treated organic product and chloride salts. In some such embodiments, different reaction parameters may be selected for hydrolysis of organic chlorides. For example, a lower temperature may be used to hydrolyze organic chlorides as compared to phospholipids. Further, in some embodiments, the hydrothermal refinement method 300 may be used to provide refinement via hydrolyzation of two or more organic compounds simultaneously. For example, a feedstock including both phospholipids and organic chlorides may be fed into the hydrothermal reactor to hydrolyze both compounds.

In some embodiments, a specific temperature may be used to conduct the hydrolysis reaction 400 that hydrolyzes the phospholipid 402 while reducing further hydrolysis of the glycerides into free fatty acids. For example, in some embodiments, the temperature within the hydrothermal reactor is held at a temperature of about 150° C. to about 275° C. (e.g., about 250° C.) to facilitate hydrolysis of the phospholipid to reduce phosphorus to less than 30 ppmw, less than 20 ppmw. less than 15 ppmw, or less than 10 ppmw and minimize hydrolysis of glycerides to less than 5%, less than 2.5%, less than 1.5%, or less than 1% of the total glycerides. In some embodiments, the flow rate of fluid within the hydrothermal reactor is also controlled to prevent further hydrolysis of glycerides and other unintended reactions. For example, in some embodiments, the linear flow rate is selected from about 1-3 ft/second. Further, in some embodiments, the pressure within the hydrothermal reactor may be selected from about 500-1200 PSI. It should be understood that the parameters described herein with respect to the hydrolysis reaction 400 may be adjusted, for example, based on the substance intended to be hydrolyzed. As such, a first combination of temperature range, pressure range, and flow rate range may be used for a first feedstock substance, while a second distinct combination of temperature range, pressure range, and flow rate range may be used for a second feedstock substance.

Features described above as well as those claimed below may be combined in various ways without departing from the scope hereof. The following examples illustrate some possible, non-limiting combinations:

Clause 1. A method of refining crude vegetable oil to meet edible oil specifications, the method comprising: mixing the crude vegetable oil with water and at least one reactant to form an oil-water mixture; feeding the oil-water mixture under pressure into a hydrothermal reactor, wherein the oil-water mixture is subject to heat within the hydrothermal reactor; within the hydrothermal reactor, maintaining the oil-water mixture within a predetermined temperature range, a predetermined pressure range, and a turbulent flow condition for a predetermined space time, wherein the predetermined temperature range, the predetermined pressure range, and the turbulent flow condition are selected to provide rapid hydrolysis of phospholipid molecules and reaction of inorganic contaminants with the at least one reactant forming inorganic salts that partition into an aqueous phase, wherein the predetermined space time is selected to reduce hydrolysis of glycerides and reduce free fatty acid content in an organic portion of the oil-water mixture, to prevent thermal cracking of organic acids, and further selected to prevent one or more compounds in the organic portion of the oil-water mixture from isomerizing to form a hydrothermal reactor effluent; and separating the hydrothermal reactor effluent into the inorganic salts in the aqueous phase and a refined vegetable oil that contains a lower concentration of the inorganic contaminants than the crude vegetable oil.

Clause 2. The method of clause 1, further comprising: heating at least one of the water, the crude vegetable oil, or the oil-water mixture to reach the predetermined temperature range.

Clause 3. The method of any of clauses 1-2, wherein the at least one reactant comprises a metal scavenger.

Clause 4. The method of any of clauses 1-3, wherein the at least one reactant is mixed with at least one of the water or the crude vegetable oil prior to mixing the crude vegetable oil and the water to form the oil-water mixture.

Clause 5. The method of any of clauses 1-4, wherein the at least one reactant is mixed with the oil-water mixture while heating the oil-water mixture or once the oil-water mixture has reached the predetermined temperature range.

Clause 6. The method of any of clauses 1-5, further comprising: stripping volatile substances from an oil phase, via a separator, including operating the separator at a reduced pressure such that a portion of the water from the oil-water mixture and the volatile substances flash to steam.

Clause 7. The method of any of clauses 1-6, wherein the predetermined temperature range is a temperature range between 150° C. to 275° C.

Clause 8. The method of clause 7, wherein the hydrothermal reactor comprises a tubular reactor designed to maintain the turbulent flow condition at a Reynolds Number of at least 4,000.

Clause 9. The method of any of clauses 1-8, wherein the hydrothermal reactor is operated at a temperature, flow rate, and residence time that results in an increase in total acid number of the organic portion of less than 500%.

Clause 10. The method of clause 9, further comprising: bleaching the refined vegetable oil after separating the hydrothermal reactor effluent to remove residual phosphorus.

Clause 11. The method of any of clauses 9-10, further comprising: removing free fatty acids, phospholipids, and chlorophyll and other color bodies via a caustic step.

Clause 12. A method of refining crude vegetable oil to meet edible oil specifications, the method comprising: mixing the crude vegetable oil comprising inorganic contaminants with water and at least one reactant to form an oil-water mixture; feeding the oil-water mixture under pressure into a hydrothermal reactor, wherein the oil-water mixture is subject to heat within the hydrothermal reactor; within the hydrothermal reactor, maintaining the oil-water mixture within a temperature range of 150° C. to 275° C., a pressure range of 100 psig to 1500 psig, and a turbulent flow condition at a Reynolds Number of at least 4,000 for a space time between 10 seconds to 2 minutes to form a hydrothermal reactor effluent; within the hydrothermal reactor, providing hydrolysis of phospholipid molecules within the space time and reacting the inorganic contaminants with the at least one reactant to form inorganic salts that partition into an aqueous phase; and separating the hydrothermal reactor effluent into the inorganic salts in the aqueous phase and a refined vegetable oil that contains a lower concentration of the inorganic contaminants than the crude vegetable oil.

Clause 13. The method of clause 12, wherein the temperature range, the pressure range, and the turbulent flow condition are selected to provide rapid hydrolysis of the phospholipid molecules.

Clause 14. The method of any of clauses 12-13, wherein the space time is selected to reduce hydrolysis of glycerides and reduce free fatty acid content in an organic portion of the oil-water mixture, to prevent thermal cracking of organic acids, and further selected to prevent one or more compounds in the organic portion of the oil-water mixture from isomerizing.

Clause 15. The method of clause 14, wherein an increase in total acid number of the organic portion is less than 300% and wherein a phosphorus content in the organic portion is reduced to less than 15 parts per million by weight.

Clause 16. The method of any of clauses 12-15, wherein an increase in total acid number of an organic portion of the oil-water mixture is less than 5 milligrams potassium hydroxide per gram of oil.

Clause 17. A method of refining crude vegetable oil to meet edible oil specifications, the method comprising: mixing the crude vegetable oil comprising inorganic contaminants with water and at least one reactant to form an oil-water mixture; feeding the oil-water mixture under pressure into a hydrothermal reactor, wherein the oil-water mixture is subject to heat within the hydrothermal reactor; within the hydrothermal reactor, maintaining the oil-water mixture within a predetermined temperature range, a predetermined pressure range, and a turbulent flow condition for a predetermined space time to form a hydrothermal reactor effluent; within the hydrothermal reactor, providing hydrolysis of phospholipid molecules within the predetermined space time and reacting the inorganic contaminants with the at least one reactant to form inorganic salts that partition into an aqueous phase; and separating the hydrothermal reactor effluent into the inorganic salts in the aqueous phase and a refined vegetable oil that contains a lower concentration of the inorganic contaminants than the crude vegetable oil.

Clause 18. The method of clause 17, wherein the hydrothermal reactor comprises a tubular reactor designed to maintain the turbulent flow condition at a Reynolds Number of at least 10,000, wherein the predetermined space time is between 10 seconds to 2 minutes.

Clause 19. The method of any of clauses 17-18, wherein an increase in total acid number of an organic portion of the oil-water mixture is less than 5 milligrams of potassium hydroxide per gram of oil, wherein a phosphorus content in the organic portion is reduced to less than 20 parts per million by weight.

Clause 20. The method of any of clauses 17-19, further comprising: bleaching the refined vegetable oil after separating the hydrothermal reactor effluent to remove residual phosphorus; and removing free fatty acids, phospholipids, and chlorophyll and other color bodies via a caustic step.

Clause 21. The method of any of clauses 1-20, wherein an increase in total acid number of an organic portion of the oil-water mixture is less than 5 milligrams of potassium hydroxide per gram of oil.

Clause 22. A method of refining crude vegetable oil to meet edible oil specifications, the method comprising: mixing the crude vegetable oil with water and at least one reactant to form an oil-water mixture; feeding the oil-water mixture under pressure into a hydrothermal reactor, wherein the oil-water mixture is subject to heat within the hydrothermal reactor; within the hydrothermal reactor, maintaining the oil-water mixture within a predetermined temperature range, a predetermined pressure range, and a turbulent flow condition for a predetermined space time, wherein the predetermined temperature range, the predetermined pressure range, and the turbulent flow condition are selected to provide hydrolysis of phospholipid molecules and reaction of inorganic contaminants with the at least one reactant forming inorganic salts that partition into an aqueous phase, wherein the predetermined space time is selected to reduce hydrolysis of glycerides and reduce free fatty acid content in an organic portion of the oil-water mixture such that an increase in total acid number of an organic portion of the oil-water mixture is less than 5 milligrams of potassium hydroxide per gram of oil; and separating the hydrothermal reactor effluent into the inorganic salts in the aqueous phase and a refined vegetable oil that contains a lower concentration of the inorganic contaminants than the crude vegetable oil.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A method of refining crude vegetable oil to meet edible oil specifications, the method comprising:
mixing the crude vegetable oil with water and at least one reactant to form an oil-water mixture;
feeding the oil-water mixture under pressure into a hydrothermal reactor, wherein the oil-water mixture is subject to heat within the hydrothermal reactor;
within the hydrothermal reactor, maintaining the oil-water mixture within a predetermined temperature range, a predetermined pressure range, and a turbulent flow condition for a predetermined space time,
wherein the predetermined temperature range, the predetermined pressure range, and the turbulent flow condition are selected to provide rapid hydrolysis of phospholipid molecules and reaction of inorganic contaminants with the at least one reactant forming inorganic salts that partition into an aqueous phase,
wherein the predetermined space time is selected to minimize hydrolysis of glycerides and minimize free fatty acid content in an organic portion of the oil-water mixture, to prevent thermal cracking of organic acids, and further selected to prevent one or more compounds in the organic portion of the oil-water mixture from isomerizing to form a hydrothermal reactor effluent; and
separating the hydrothermal reactor effluent into the inorganic salts in the aqueous phase and a refined vegetable oil that contains a lower concentration of the inorganic contaminants than the crude vegetable oil.

2. The method of claim 1, further comprising:
heating at least one of the water, the crude vegetable oil, or the oil-water mixture to reach the predetermined temperature range.

3. The method of claim 1, wherein the at least one reactant comprises a metal scavenger.

4. The method of claim 1, wherein the at least one reactant is mixed with at least one of the water or the crude vegetable oil prior to mixing the crude vegetable oil and the water to form the oil-water mixture.

5. The method of claim 1, wherein the at least one reactant is mixed with the oil-water mixture while heating the oil-water mixture or once the oil-water mixture has reached the predetermined temperature range.

6. The method of claim 1, further comprising:
stripping volatile substances from an oil phase, via a separator, including operating the separator at a reduced pressure such that a portion of the water from the oil-water mixture and the volatile substances flash to steam.

7. The method of claim 1, wherein the predetermined temperature range is a temperature range between 150° C. to 275° C.

8. The method of claim 7, wherein the hydrothermal reactor comprises a tubular reactor designed to maintain the turbulent flow condition at a Reynolds Number of at least 4,000.

9. The method of claim 1, wherein the hydrothermal reactor is operated at a temperature, flow rate, and residence time that results in an increase in total acid number of the organic portion of less than 500%.

10. The method of claim 9, further comprising:
bleaching the refined vegetable oil after separating the hydrothermal reactor effluent to remove residual phosphorus.

11. The method of claim 9, further comprising:
removing free fatty acids, phospholipids, and chlorophyll and other color bodies via a caustic step.

12. A method of refining crude vegetable oil to meet edible oil specifications, the method comprising:
mixing the crude vegetable oil comprising inorganic contaminants with water and at least one reactant to form an oil-water mixture;
feeding the oil-water mixture under pressure into a hydrothermal reactor, wherein the oil-water mixture is subject to heat within the hydrothermal reactor;
within the hydrothermal reactor, maintaining the oil-water mixture within a temperature range of 150° C. to 275° C., a pressure range of 100 psig to 1500 psig, and a turbulent flow condition at a Reynolds Number of at least 4,000 for a space time between 10 seconds to 2 minutes to form a hydrothermal reactor effluent;
within the hydrothermal reactor, providing hydrolysis of phospholipid molecules within the space time and reacting the inorganic contaminants with the at least one reactant to form inorganic salts that partition into an aqueous phase; and
separating the hydrothermal reactor effluent into the inorganic salts in the aqueous phase and a refined vegetable oil that contains a lower concentration of the inorganic contaminants than the crude vegetable oil.

13. The method of claim 12, wherein the temperature range, the pressure range, and the turbulent flow condition are selected to provide rapid hydrolysis of the phospholipid molecules.

14. The method of claim 12, wherein the space time is selected to reduce hydrolysis of glycerides and reduce free fatty acid content in an organic portion of the oil-water mixture, to prevent thermal cracking of organic acids, and further selected to prevent one or more compounds in the organic portion of the oil-water mixture from isomerizing.

15. The method of claim 14, wherein an increase in total acid number of the organic portion is less than 300% and wherein a phosphorus content in the organic portion is reduced to less than 15 parts per million by weight.

16. The method of claim 12, wherein an increase in total acid number of an organic portion of the oil-water mixture is less than 5 milligrams of potassium hydroxide per gram of oil.

17. A method of refining crude vegetable oil to meet edible oil specifications, the method comprising:
mixing the crude vegetable oil comprising inorganic contaminants with water and at least one reactant to form an oil-water mixture;
feeding the oil-water mixture under pressure into a hydrothermal reactor, wherein the oil-water mixture is subject to heat within the hydrothermal reactor;
within the hydrothermal reactor, maintaining the oil-water mixture within a predetermined temperature range, a predetermined pressure range, and a turbulent flow condition for a predetermined space time to form a hydrothermal reactor effluent;
within the hydrothermal reactor, providing rapid hydrolysis of phospholipid molecules within the predetermined space time and reacting the inorganic contaminants with the at least one reactant to form inorganic salts that partition into an aqueous phase; and
separating the hydrothermal reactor effluent into the inorganic salts in the aqueous phase and a refined vegetable oil that contains a lower concentration of the inorganic contaminants than the crude vegetable oil.

18. The method of claim 17,
wherein the hydrothermal reactor comprises a tubular reactor designed to maintain the turbulent flow condition at a Reynolds Number of at least 10,000,
wherein the predetermined space time is between 10 seconds to 2 minutes.

19. The method of claim 17,
wherein an increase in total acid number of an organic portion of the oil-water mixture is less than 5 milligrams of potassium hydroxide per gram of oil,
wherein a phosphorus content in the organic portion is reduced to less than 20 parts per million by weight.

20. The method of claim 17, further comprising:
bleaching the refined vegetable oil after separating the hydrothermal reactor effluent to remove residual phosphorus; and
removing free fatty acids, phospholipids, and chlorophyll and other color bodies via a caustic step.
